(19) United States
(12) Patent Application Publication
(10) Pub. No.: US 2018/0121353 A1
(43) Pub. Date: May 3, 2018

(54) SYSTEM, METHOD, AND APPARATUS FOR REDUCING REDUNDANT WRITES TO MEMORY BY EARLY DETECTION AND ROI-BASED THROTTLING

(71) Applicant: Intel Corporation, Santa Clara, CA (US)

(72) Inventors: Jayesh Gaur, Bangalore (IN); Sreenivas Subramoney, Bangalore (IN); Leon Polishuk, Haifa (IL)

(21) Appl. No.: 15/335,924

(22) Filed: Oct. 27, 2016

(51) Int. Cl. G06F 12/0804; G06F 12/0811

(52) U.S. Cl. CPC G06F 12/0804; G06F 12/0811; G06F 2212/69; G06F 2212/283; G06F 2212/608; G06F 2212/1008

(57) ABSTRACT

Systems, methods, and processors to reduce redundant writes to memory. An embodiment of a system includes: a plurality of processors; a memory coupled to one of more of the plurality of processors; a cache coupled to the memory such that a dirty cache line evicted from the cache is written to the memory; and a redundant write detection circuitry coupled to the cache, wherein the redundant write detection circuitry to control write access to the cache based on a redundancy check of data to be written to the cache. The system may include a first predictor circuitry to deactivate the redundant write detection circuitry responsive to a determination that power consumed by the redundancy check is greater than the power it saves, or a second predictor circuitry to deactivate the redundant write detection circuitry when memory bandwidth saved from performing the redundancy check is not being utilized by memory reads.

### FIELD

Embodiments of the invention relate to the field of computer architecture, and more specifically, to data transfer.

### BACKGROUND INFORMATION

Modern computer systems employ a multi-level cache/memory hierarchy to efficiently store and retrieve data needed to execute programs. A typical cache hierarchy includes different levels of cache, such as Level 1 (L1), Level 2 (L2), and Level 3 (L3) caches. L3 cache is also known as the Last Level Cache (LLC) because it is the last cache where data can be cached or retrieved before memory is accessed. Caches are usually part of the central processing unit (CPU) or very close to it. They provide to the CPU temporary storage and quick access to data frequently used by an executing program. In comparison, memory, which typically refers to the Random Access Memory (RAM), requires a much longer access time.

Memory bandwidth, or the data traffic to and from the memory, is often a critical and highly coveted resource in the computing system. Memory bandwidth is primarily consumed by reads and writes to memory. Typically, a read to memory is initiated by a requests from a processor core to read a particular cache line that cannot be found in the caches (i.e. a cache miss). As a result, a copy of the requested cache line must be fetched from memory and stored into the cache so that the processor core can continue executing the program that requires the requested cache line. A write to memory, on the other hand, is typically initiated by an eviction of a modified (also known as “dirty”) cache line from the LLC. Since the evicted cache line is modified thus may contain new data, it needs to be stored into memory in order to preserve the new data. Memory reads are critical as they provide the data needed for a processor or core to perform its tasks (e.g., executing a programs). In contrast, memory writes are usually less critical and are carried out mainly to preserve changes made to the data. Since there is only a limited amount of total memory bandwidth available for performing memory reads and writes, any bandwidth that is consumed by a memory write takes away from the bandwidth that would otherwise be available for memory reads.

Through observing simulations and real world applications, it is discovered that many writes to memory are redundant or unnecessary as they do not actually modify the data stored in memory. This is especially common in scenarios where a core writes a large data array (e.g., data spanning several cache lines) but only a few cache lines in that data array are actually modified. When these cache lines are evicted from the LLC, many of them would result in redundant writes to memory because they contain the same data as what is already stored in memory. Similar problem occurs when a cache line containing zero data is being written again to memory with zero data. This is often the case when initializing or resetting a variable by zeroing out its content (e.g., x=0).

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein like reference numerals refer to like parts throughout the various views unless otherwise specified:

FIG. 1 shows an exemplary configuration of a host platform according to an embodiment;

FIG. 2 is a schematic diagram illustrating an abstracted view of a memory coherency architecture employed by an embodiment of the present invention;

FIG. 3 is a graph illustrating the reduction in write traffic to memory when redundant writes to the LLC are removed according an embodiment of the present invention;

FIG. 4A is a schematic diagram a typical memory access sequence in which a cache line is accessed from system memory and copied various caches;

FIG. 4B is a schematic diagram illustrating an embodiment of a redundant write detection mechanism for preventing redundant writes to the LLC;

FIG. 4C is a schematic diagram illustrating an optimized redundant write detection mechanism according to an embodiment;

FIG. 5 is a flow chart illustrating operations and logic for implementing a redundant write detection mechanism according to one embodiment;

FIG. 6 is a flow chart illustrating operations and logic for implementing a predictor to control activation and deactivation of redundant write detection mechanism according to one embodiment;

FIG. 7A is a block diagram illustrating both an exemplary in-order pipeline and an exemplary register renaming, out-of-order issue/execution pipeline according to embodiments of the invention;

FIG. 7B is a block diagram illustrating both an exemplary embodiment of an in-order architecture core and an exemplary register renaming, out-of-order issue/execution architecture core to be included in a processor according to embodiments of the invention;

FIG. 8 is a block diagram of a single core processor and a multicore processor with integrated memory controller and graphics according to embodiments of the invention;

FIG. 9 illustrates a block diagram of a system in accordance with one embodiment of the present invention;

FIG. 10 illustrates a block diagram of a second system in accordance with an embodiment of the present invention;

FIG. 11 illustrates a block diagram of a third system in accordance with an embodiment of the present invention;

FIG. 12 illustrates a block diagram of a system on a chip (SoC) in accordance with an embodiment of the present invention; and

FIG. 13 illustrates a block diagram contrasting the use of a software instruction converter to convert binary instructions in a source instruction set to binary instructions in a target instruction set according to embodiments of the invention.

### DETAILED DESCRIPTION

Embodiments of system, method, and apparatus for reducing redundant writes to memory by early detection and ROI-based throttling are described herein. In the following description, numerous specific details are set forth to provide a thorough understanding of embodiments of the invention. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

Reference throughout this specification to “one embodiment” or “an embodiment” means that a particular feature, structure, or characteristic described in connection with the embodiment is included in at least one embodiment of the present invention. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

For clarity, individual components in the Figures herein may also be referred to by their labels in the Figures, rather than by a particular reference number. Additionally, reference numbers referring to a particular type of component (as opposed to a particular component) may be shown with a reference number followed by “(typ)” meaning “typical.” It will be understood that the configuration of these components will be typical of similar components that may exist but are not shown in the drawing Figures for simplicity and clarity or otherwise similar components that are not labeled with separate reference numbers. Conversely, “(typ)” is not to be construed as meaning the component, element, etc. is typically used for its disclosed function, implement, purpose, etc.

One aspect of the present invention provides a mechanism for detecting and preventing redundant writes to memory by blocking redundant writes at the last level cache. In one embodiment, the existing cache/memory coherency mechanism is utilized to get cache line and data from memory into the LLC. In a multi-core processor system with coherent cache and memory, data stores made by a requesting core typically begins with a Read for Ownership (RFO) message which obtains ownership of the cache line to which the store is made. This is to ensure data coherency between the various caches and memory. As will be further detailed below, if a cache line request misses in all the caches (i.e., L1, L2, and L3/LLC), a copy of the requested cache line will be read from main memory and cached into the LLC, as well as the requesting core's L1 and/or L2 caches. Thus, every RFO operation effectively brings a current copy of the requested cache line into the LLC. Once ownership of the requested cache line is established by the requesting core, the actual store operation takes place in the requesting core's L1 cache. Thereafter, through well-known eviction algorithms, a modified cache line will eventually be evicted from L1 to L2, then from L2 to the LLC.

In the current cache coherence protocol, there is no mechanism for determining whether or not a cache line being written to the LLC is the same as the existing cache line already in the LLC. Rather, when a dirty cache line is evicted from the L2 cache to the LLC, it is simply written into the LLC with its cache coherency state set as (M)odified. When this dirty cache line is later evicted from the LLC, it is written to memory regardless of whether there are actual changes made to the cache line. In contrast, according to embodiments of the present invention, a cache line write back or dirty eviction into the LLC is checked for redundancy. This includes checking whether the data to be written to a cache line in the LLC is the same as the data of the cache line already in the LLC. In one embodiment, when a cache line is being written back by the core or evicted from L2 to the LLC, a redundant write detection mechanism checks the data in the evicted cache line against the data of the corresponding cache line in the LLC. According to and embodiment, the redundant write detection mechanism is implemented by or as part of the LLC cache agent or controller. In another embodiment, the redundant write detection mechanism is a component separate from the LLC and its corresponding cache agent or controller. The redundant write detection mechanism may be implemented by software, hardware, firmware, or any combination thereof.

If redundant write detection mechanism determines that there is no difference between the data in the two cache lines, indicating a redundant write, the evicted cache line is not written into the LLC and the existing cache line in the LLC is not marked (M)odified. This prevents an unnecessary memory write down the road because only the cache lines in LLC that are marked (M)odified are written into memory. It is desirable to perform this check at the LLC as opposed to, for example, at L1 or L2 cache because dirty cache lines from those caches, when evicted, are simply written into the next level cache rather than to the main memory. As such, cache lines written back into the L1 or L2 cache, when evicted, do not directly result in writes to the memory and thus do not affect memory bandwidth.

According to an embodiment, to optimize the detection of redundant writes associated with dirty evictions from L2 to LLC, a LLC data read is performed in parallel with a LLC tag lookup. In typical LLC operations today, when a dirty cache line is evicted from the L2 to the LLC, a request is first made to LLC to determine whether there is already a copy of the evicted cache line in the LLC. This is performed by a tag look up. Next, the LLC, upon determining a cache hit, sends an acknowledgement or a write-pull request to the L2 cache to request for the evicted cache line. In addition, the LLC allocates space in a write buffer for temporarily storing the impending cache line from the L2 cache. Responsive to receiving the acknowledgment or write-pull request, the L2 cache sends the evicted cache line. According to an embodiment, the evicted cache line is sent to and stored in the write buffer. Later, when the write buffer is processed, the evicted cache line will be checked for data redundancy by the redundant write detection mechanism discussed above before it is written to the LLC. All in all, the write detection mechanism causes two reads to the LLC—once for the tag look up and once for reading the cache line for data comparison. To reduce the number of accesses to the LLC, an embodiment of the present invention performs the reading of cache line in the LLC in parallel with the tag look up. Specifically, once the tag lookup results in a hit, the corresponding cache line is read from the LLC and stored in the write buffer. Thereafter, upon receiving the evicted dirty cache line from L2, the data between the evicted cache line is compared with the cache line stored in the buffer. Since the read LLC cache line is already in the write buffer, the LLC is not accessed again, thereby putting no additional pressure on the LLC cache bandwidth.

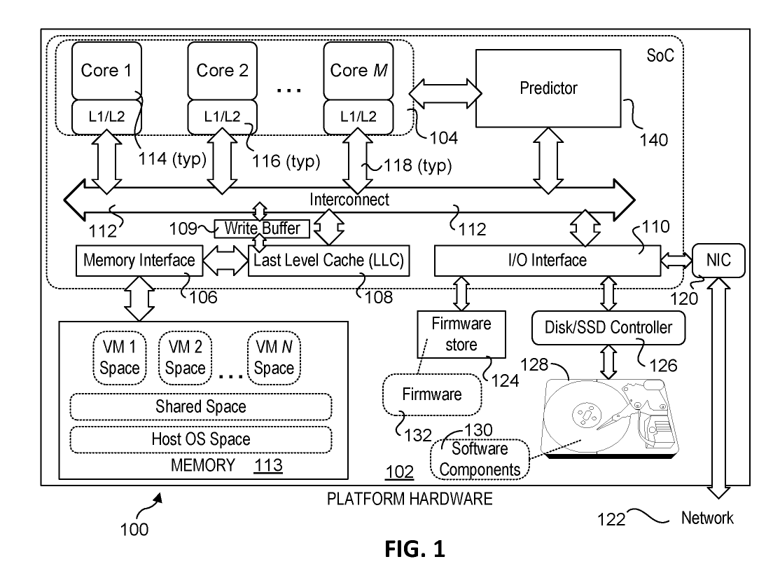

FIG. 1 shows an exemplary configuration of a host platform according to an embodiment. Platform hardware 102 includes a central processing unit (CPU) 104 coupled to a memory interface 106, a last level cache (LLC) 108, a write buffer 109 associated with the LLC, and an input/output (I/O) interface 110 via an interconnect 112. The LLC may optionally be referred to as Level 3 (L3) cache. In some embodiments, all or a portion of the foregoing components may be integrated on a System on a Chip (SoC). Memory interface 106 is configured to facilitate access to system memory 113, which will usually be separate from the SoC.

CPU 104 includes a core portion including M processor cores 114, each including a local level 1 (L1) and level 2 (L2) cache 116. Optionally, the L2 cache may be referred to as a “middle-level cache” (MLC). As illustrated, each processor core 114 has a respective connection 118 to interconnect 112 and operates independently from the other processor cores.

For simplicity, interconnect 112 is shown as a single double-ended arrow representing a single interconnect structure; however, in practice, interconnect 112 is illustrative of one or more interconnect structures within a processor or SoC, and may comprise a hierarchy of interconnect segments or domains employing separate protocols and including applicable bridges for interfacing between the interconnect segments/domains. For example, the portion of an interconnect hierarchy to which memory and processor cores are connected may comprise a coherent memory domain employing a first protocol, while interconnects at a lower level in the hierarchy will generally be used for I/O access and employ non-coherent domains. The interconnect structure on the processor or SoC may include any existing interconnect structure, such as buses and single or multi-lane serial point-to-point, ring, or mesh interconnect structures.

I/O interface 110 is illustrative of various I/O interfaces provided by platform hardware 102. Generally, I/O interface 110 may be implemented as a discrete component (such as an ICH (I/O controller hub) or the like), or it may be implemented on an SoC. Moreover, I/O interface 110 may also be implemented as an I/O hierarchy, such as a Peripheral Component Interconnect Express (PCIe™) I/O hierarchy. I/O interface 110 further facilitates communication between various I/O resources and devices and other platform components. These include a Network Interface Controller (NIC) 120 that is configured to facilitate access to a network 122, and various other I/O devices, which include a firmware store 124, a disk/SSD controller 126, and a disk drive 128. More generally, disk drive 128 is representative of various types of non-volatile storage devices, including both magnetic- and optical-based storage devices, as well as solid-state storage devices, such as solid state drives (SSDs) or Flash memory.

The multiple cores 114 of CPU 104 are employed to execute various software components 130, such as modules and applications, which are stored in one or more non-volatile storage devices, such as depicted by disk drive 128. Optionally, all or a portion of software components 130 may be stored on one or more storage devices (not shown) that are accessed via a network 122

During boot up or run-time operations, various software components 130 and firmware 132 are loaded into system memory 113 and executed on cores 114 as processes comprising execution threads or the like. Depending on the particular processor or SoC architecture, a given “physical” core may be implemented as one or more logical cores, with processes being allocated to the various logical cores. For example, under the Intel® Hyperthreading™ architecture, each physical core is implemented as two logical cores. Under a typical system boot for platform hardware 102, firmware 132 will be loaded and configured in system memory 113, followed by booting a host operating system (OS).

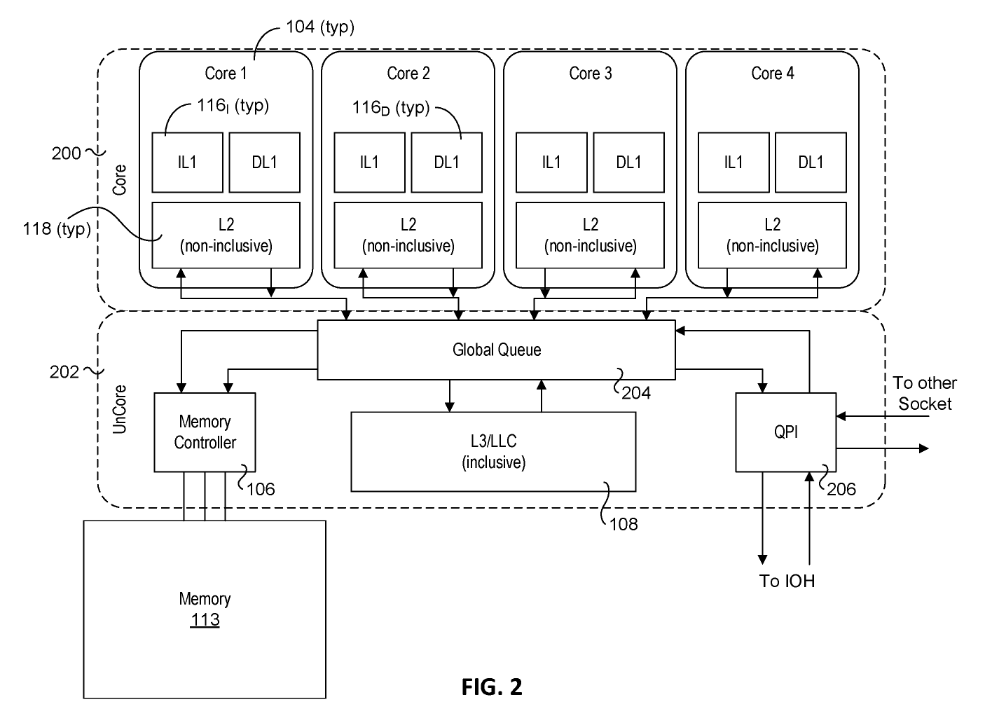

FIG. 2 is a schematic diagram illustrating an abstracted view of a memory coherency architecture employed by an embodiment of the present invention. Under this and similar architectures, such as employed by many Intel® processors, the L1 and L2 caches are part of a coherent memory domain under which memory coherency is managed by coherency mechanisms in the processor core 200. Each core 104 includes a L1 instruction (IL1) cache 116I, and L1 data cache (DL1) 116D, and an L2 cache 118. Each of these caches is associated with a respective cache agent (not shown) that makes up part of the coherency mechanism. L2 caches 118 are depicted as non-inclusive, meaning they do not include copies of any cache lines in the L1 instruction and data caches for their respective cores. As an option, L2 may be inclusive of L1, or may be partially inclusive of L1. In addition, L3, also known as LLC, may be non-inclusive of L2. As yet another option, L1 and L2 may be replaced by a cache occupying a single level in cache hierarchy.

The LLC is considered part of the “uncore” 202, wherein memory coherency is extended through coherency agents, resulting in additional overhead and processor cycles. As shown, uncore 202 includes memory controller 106 coupled to external memory 113 and a global queue 204. Global queue 204 also is coupled to an L3 cache 108, and a QuickPath Interconnect® (QPI) interface 206. Optionally, interface 206 may comprise a Keizer Technology Interface (KTI). L3 cache 108 (which functions as the LLC in this architecture) is inclusive, meaning that it includes is a copy of each cache line in the L1 and L2 caches.

As is well known, as one gets further away from a core, the size of the cache levels increase. However, as the cache size increase, so does the latency incurred in accessing cache lines in the caches. The L1 caches are the smallest (e.g., 32-64 KiloBytes (KB)), with L2 caches being somewhat larger (e.g., 256-640 KB), and LLCs being larger than the typical L2 cache by an order of magnitude or so (e.g., 8-16 MB). Nonetheless, the size of these caches is dwarfed when compared to the size of system memory, which is typically on the order of GigaBytes. Generally, the size of a cache line at a given level in a memory hierarchy is consistent across the memory hierarchy, and for simplicity and historical references, lines of memory in system memory are also referred to as cache lines even though they are not actually in a cache. It is further noted that the size of global queue 204 is quite small, as it is designed to only momentarily buffer cache lines that are being transferred between the various caches, memory controller 106, and QPI interface 206. In some embodiments, the global queue serves the same function as the write buffer 109 of FIG. 1 by temporarily buffering cache lines to be written into the LLC.

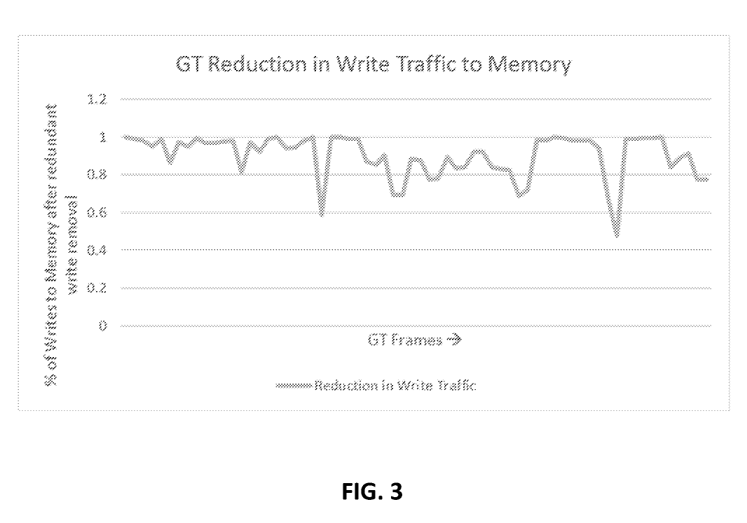

FIG. 3 is a graph illustrating the reduction in write traffic to memory when redundant writes to the LLC are removed by an embodiment of the present invention. The graph shows a clear reduction to memory writes for a set graphics traffic (GT) benchmarks. For some frames, the reduction can be as much as 20-30%.

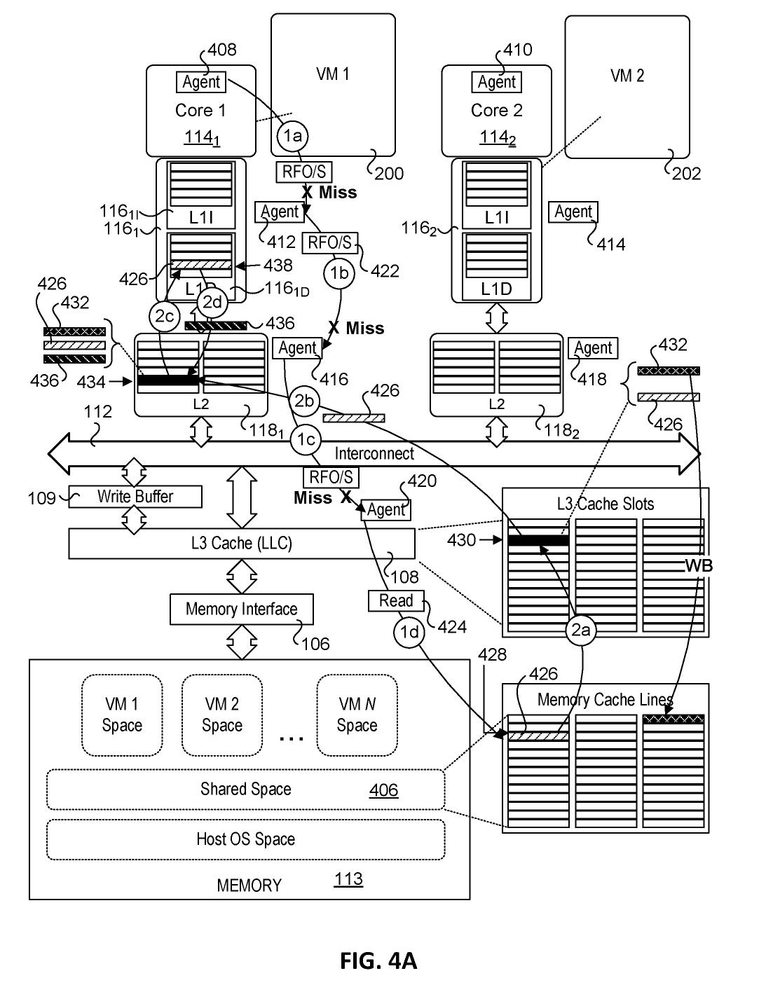

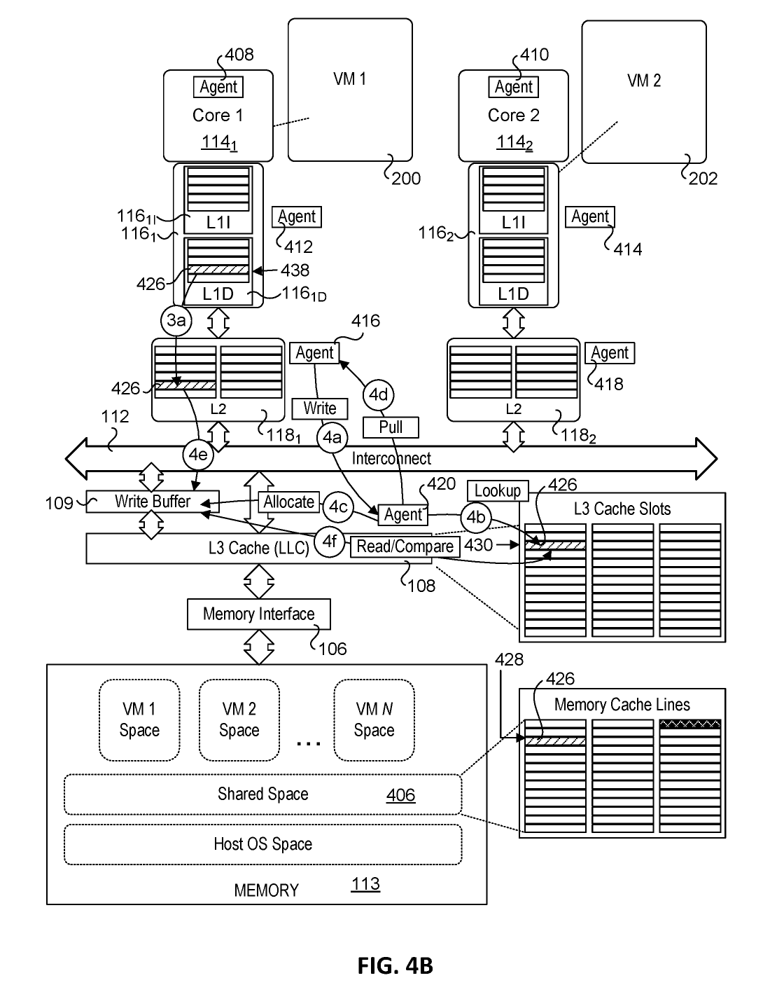

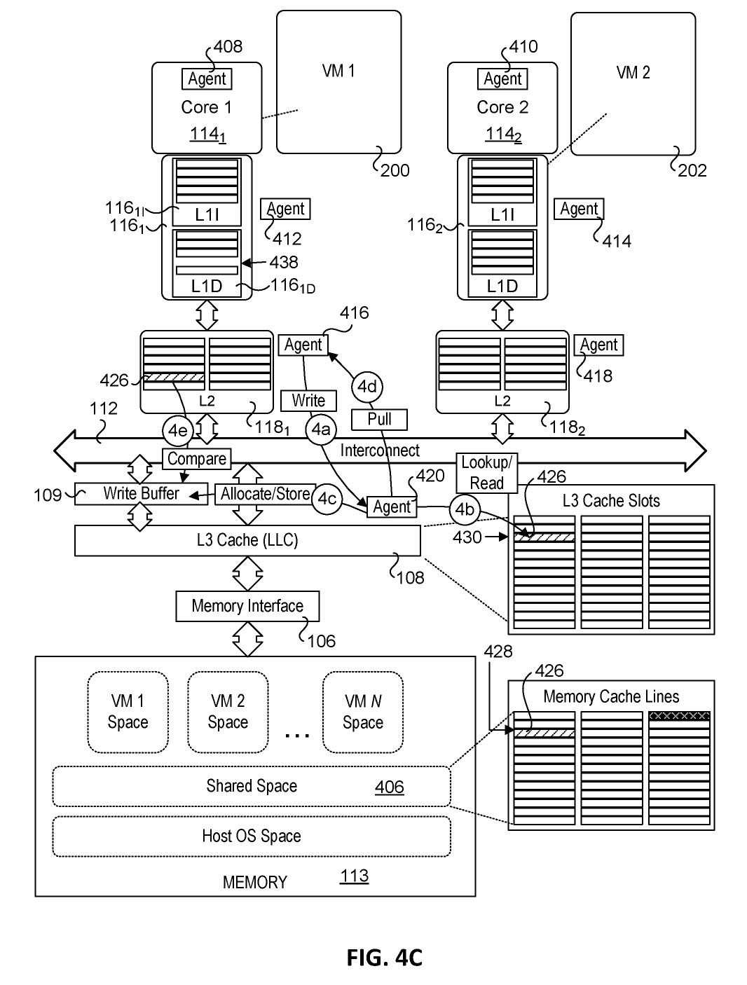

FIG. 4A illustrates a typical memory access sequence in which a cache line is accessed from system memory and copied into L1 cache 1161 of core 1141 and the LLC 108. Data in system memory is stored in memory blocks (also referred to by convention as cache lines as discussed above), and each memory block has an associated address, such as a 64-bit address for today's 64-bit processors. From the perspective of applications, which includes the producers and consumers, a given chunk of data (data object) is located at a location in system memory beginning with a certain memory address, and the data is accessed through the application's host OS. Generally, the memory address is actually a virtual memory address, and through some software and hardware mechanisms, such virtual addresses are mapped to physical addresses behind the scenes. Additionally, the application is agnostic to whether all or a portion of the chunk of data is in a cache. On an abstract level, the application will ask the operating system to fetch the data (typically via address pointers), and the OS and hardware will return the requested data to the application. Thus, the access sequence will get translated by the OS as a request for one or more blocks of memory beginning at some memory address which ends up getting translated (as necessary) to a physical address for one or more requested cache lines.

As illustrated in FIG. 4A, each of the cores 1141 and 1142 include a respective L1 cache 1161 and 1162, and a respective L2 cache 1181 and 1182, each including multiple cache lines depicted as rectangular blocks. LLC 108 includes a set of LLC cache lines 430, and system memory 113 likewise includes multiple cache lines, including a set of memory cache lines 426 corresponding to a portion of shared space 406. Also shown are multiple cache agents that are used to exchange messages and transfer data in accordance with a cache coherency protocol. The agents include core agents 408 and 410, L1 cache agents 412 and 414, L2 cache agents 416 and 418, and an L3 cache agent 420.

The access sequence of a requested cache line from memory would begin with core 1141 sending out a Read for Ownership (RFO) message and first “snooping” (i.e., checking) its local L1 and L2 caches to see if the requested cache line is currently present in either of those caches. In this example, VM1 200 desires to access the cache line so its data can be modified, and thus the RFO is used rather than a Read request. The presence of a requested cache line in a cache is referred to as a “hit,” while the absence is referred to as a “miss.” This is done using well-known snooping techniques, and the determination of a hit or miss is based on information maintained by each cache identifying the addresses of the cache lines that are currently present in that cache. As discussed above, the L2 cache is non-inclusive, making the L1 and L2 caches exclusive, meaning the same cache line will not be present in both of the L1 and L2 caches for a given core. Under an operation 1a, core agent 408 sends an RFO message with snoop (RFO/S) 422 to L1 cache agent 412, which results in a miss. During an operations 1b, L1 cache agent 412 the forwards RFO/snoop message 422 to L2 cache agent 416, resulting in another miss.

In addition to snooping a core's local L1 and L2 caches, the core will also snoop L3 cache 108. If the processor employs an architecture under which the L3 cache is inclusive, meaning that a cache line that exists in L1 or L2 for any core also exists in the L3, the core knows the only valid copy of the cache line is in system memory if the L3 snoop results in a miss. If the L3 cache is not inclusive, additional snoops of the L1 and L2 caches for the other cores may be performed. In the example of FIG. 4A, L2 agent 416 forwards RFO/snoop message 422 to L3 cache agent 420, which also results in a miss. Since L3 is inclusive, it does not forward RFO/snoop message 422 to cache agents for other cores.

In response to detecting that the requested cache line is not present in L3 cache 108, L3 cache agent 420 sends a Read request 424 to memory interface 106 to retrieve the cache line from system memory 113, as depicted by an access operation 1d that accesses a cache line 426, which is stored at a memory address 428. As depicted by a copy operation 2a, the Read request results in cache line 426 being copied into a cache line slot 430 in L3 cache 108. Presuming that L3 is full, this results in eviction of a cache line 432 that currently occupies slot 430. Generally, the selection of the cache line to evict (and thus determination of which slot in the cache data will be evicted from and written to) will be based on one or more cache eviction algorithms that are well-known in the art. If cache line 432 is in a modified state, cache line 432 will be written back to memory 113 (known as a cache write-back) prior to eviction, as shown. As further shown, there was a copy of cache line 432 in a slot 434 in L2 cache 1181, which frees this slot. Cache line 426 is also copied to slot 434 during an operation 2b.

Next, cache line 426 is to be written to L1 data cache 1161D. However, this cache is full, requiring an eviction of one of its cache lines, as depicted by an eviction of a cache line 436 occupying a slot 438. This evicted cache line is then written to slot 434, effectively swapping cache lines 426 and 436, as depicted by operations 2c and 2d. At this point, core 1141 has exclusive ownership of cache line 426 (i.e. cache line 426 in L1 cache 1161 is marked as (E)xclusive). Core 1141 may thus modify cache line 426 by, for example, writing data to it. Once modified by core 1141, cache line 426 will be in (M)odified state, also known as dirty.

Thereafter, new writes and new reads may be performed by core 1141 which would repeat the operations 1a through 2d causing new cache lines to be installed into L1 cache 1161. At some point, cache line 426 will be evicted from the L1 cache 1161 to L2 cache 1181, similar to what happened with cache line 436. From there, as new cache lines are stored into the L2 cache 1181, eventually cache line 426 will be evicted to L3 cache. The L3 cache or the last level cache, as the name suggests, is the last cache a cache line can be stored before it is moved to memory 113. Thus, if cache line 426 is evicted again, it would be written back to memory 113 which would consume memory bandwidth. This is normal and desirable if the modified cache line 426 contains new data that needs to be preserved into memory. However, if the data in modified cache line 426 is the same as the cache line 426 stored in slot 428 of memory 113, such write would be redundant and a waste of memory bandwidth. Therefore, it is desirable to ensure that cache line 426 in L3 cache 108 is only written to memory if it would modify the copy of cache line 426 in memory.

FIG. 4B illustrates an embodiment of a redundant write detection mechanism for ensuring that cache lines evicted from the L2 cache 1181 (e.g., cache line 426) are stored into the L3 cache 108 only if they contain data different than the data of corresponding cache lines already in the L3 cache 108. The eviction of cache line 426 begins at 3a where it is evicted from L1 cache 1161 to L2 cache 1181. The details of this eviction is omitted. Thereafter, cache line 426 is to be evicted from L2. The L2 cache agent 416 sends a write request to L3 cache agent 420 to notify about the impending eviction of cache line 426. This is illustrated by operation 4a. Upon receiving the notice of impending write, L3 cache agent 420 performs a tag look up of cache line 426 in the L3 cache, illustrated by operation 4b. Upon a hit, L3 cache agent 420 allocates space in the write buffer 109, as shown by operation 4c. L3 cache agent 420 then sends a write-pull request to L2 cache agent 416 via operation 4d. Responsive to the write-pull request, cache line 426 is sent from L2 cache 1181 to the write buffer 109. This is illustrated by operation 4e. Next, cache line 426 in the L3 cache at slot 430 is read and compared with cache line 426 in the buffer, as illustrated by operation 4f. If the two cache lines are different, indicating that cache line in the buffer contains new data, the operation would proceed as normal. This means cache line 426 in the buffer is stored into the L3 cache and marked as (M)odified. Later, when it gets evicted from the L3 cache, it will be written back into the memory. On the other hand, if cache line 426 in the buffer is the same as the cache line in the L3 cache, signaling a redundant write, cache line 426 is removed from the buffer and the write request is dropped. This prevents cache line 426 from being installed into the L3 cache and marked as (M)odified, which in turn eliminates a redundant memory write when cache line 426 is evicted from the L3 cache.

The redundant write detection mechanism illustrated in FIG. 4B performs two reads to the L3 buffer, once for tag look up and once to actually read the cache line to be compared with the cache line in the buffer. Each of these reads consumes L3 cache bandwidth, puts pressure on agent 420 of L3 cache, and requires extra power. According to an embodiment of the present invention, a read to the L3 cache can be eliminated by performing in parallel the tag lookup and the reading of cache line. FIG. 4C illustrates such optimized redundant write detection mechanism according to an embodiment. When cache line 426 is to be evicted from L2 cache 1181, L2 cache agent 416 sends a write request to L3 cache agent 420 to notify about the impending eviction of cache line 426, as illustrated by operation 4a. Upon receiving the notice of impending write, L3 cache agent 420 performs a tag look up of cache line 426 in the L3 cache, illustrated by operation 4b. Upon a hit, the L3 cache agent 420 reads cache line 426 from L3 cache and stores it in the write buffer 109, as illustrated by operation 4c. In addition, the L3 cache agent 420 also sends a write-pull request to the L2 cache agent 416 via operation 4d. Responsive to the write-pull request, cache line 426 is sent from L2 cache 1181 to the write buffer 109. At operation 4e, the cache line 426 from L2 cache arriving at the buffer is compared with cache line 426 stored in the buffer from operation 4c. If the two cache lines are different, indicating that cache line from L2 cache contains new data, cache line 426 that is already in the buffer is removed and replaced with cache line 426 from the L2 cache. When write buffer is later processed, cache line 426 will be written into L3 cache 108 and marked as (M)odified. Thereafter, when cache line 426 is eventually evicted from the L3 cache, it will be written back into the memory. On the other hand, if cache line 426 from L2 cache is the same as the cache line in the buffer, signaling a redundant write, the cache line 426 from L2 cache is dropped while the cache line 426 that is already in the buffer is removed from the buffer. In addition, the write request is also dropped. The removal of cache line 426 from the write buffer prevents it from being written into the L3 cache and marked as (M)odified. Furthermore, it also prevents a redundant memory write when cache line 426 is later evicted from the L3 cache, because cache line 426 will not be in the (M)odified state and thus requires no memory write back.

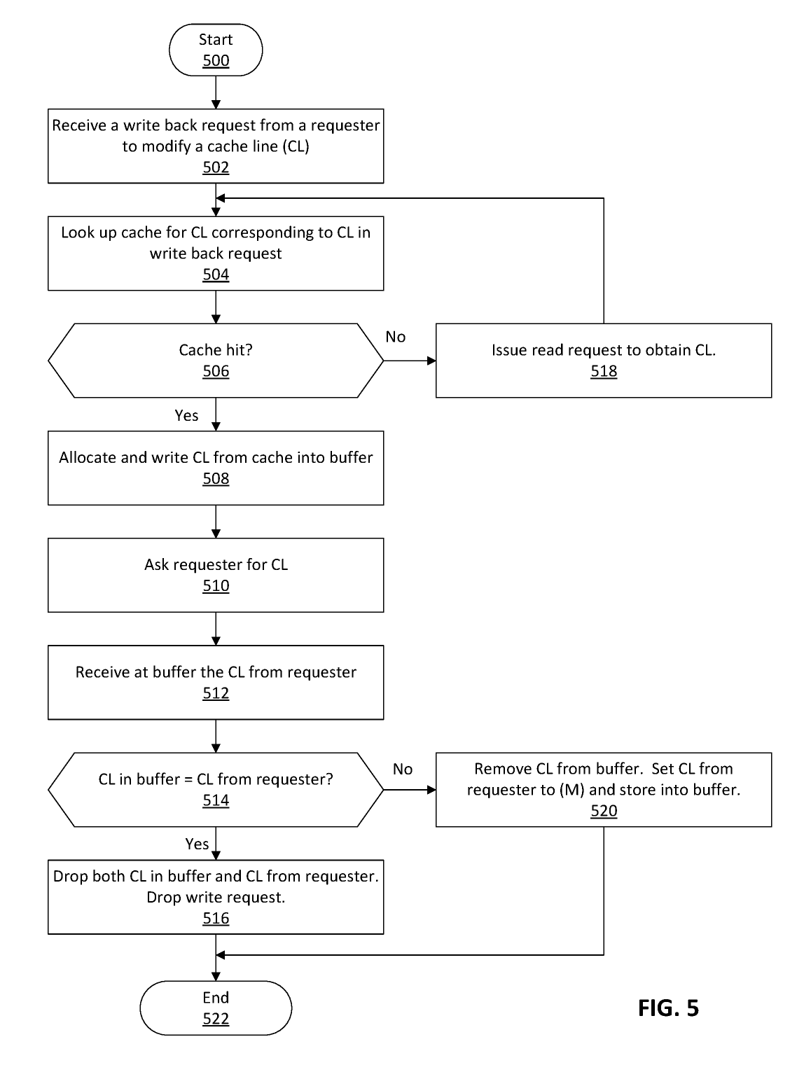

FIG. 5 illustrates an embodiment of a method for detecting redundant writes to a cache. The method may be implemented in a cache, such as the L3 cache or the LLC. In one embodiment, the method is performed by a cache agent or a cache controller. The method begins at block 500. At block 502, a write back request sent by a requester is received by a cache or a cache agent/controller. According to an embodiment, the write back request may originate from the core or be triggered by a cache line eviction notice from another cache. At block 504, a look up is performed in the cache to determine whether a cache line that corresponds to the cache line in the write back request exists in the cache. If, at block 506, no matching cache line is found in the cache indicating a cache miss, a read is issued by the cache or cache agent to obtain a copy of the cache line. According to an embodiment, a cache line corresponding to the write back request is read from the memory. Thereafter, the method returns to block 504 to perform another look up in the cache.

On the other hand, if, at block 506, a matching cache line is found in the cache signaling a cache hit, a buffer is allocated and the matched cache line in the LLC is copied to the buffer at block 508. At block 510, a request (e.g. a write-pull request) is sent to the requester to obtain the cache line to be written into the LLC. In response to the request, the requester sends the cache line to be written into the LLC. At block 512, the cache line sent from the requester is received by the buffer. At block 514, a comparison is made between the cache line received from the requester and the cache line that was already in the buffer. If the two cache lines are the same, indicating a redundant right, both cache lines are removed or dropped from the buffer at 516. Similarly, the write back request is also dropped. On the other hand, if the determination at block 514 was that the two cache lines are different, the cache line that was in the buffer is removed. In addition, the cache line received from the requester stored into the write buffer and marked as (M)odified. Thereafter, when the write buffer is processed, the modified cache line will be written into the cache as a dirty cache line that needs to be written back to memory if evicted. The method ends at block 522.

In the redundant write detection mechanism describe above, reading a cache line from the L3 cache for every write-back request consumes power regardless of whether a redundant write is prevented or not. In cases where a redundant write is prevented from writing to the LLC and subsequently to the memory, the power spent on cache reads is easily offset by the power saved from omitted redundant writes. However, in cases where redundant writes are far and in between, the extra power consumed by the redundant write detection mechanism are wasted without any added benefit. As such, another aspect of the invention introduces a predictor mechanism based on set sampling, to intelligently deactivate the redundant write detection mechanism when conditions change. According to an embodiment, a power cost is attached to every read to the LLC that is the result of a write back request. This cost is denoted by P(R-LLC) and represents the power consumed to perform a read or a lookup of a cache line in the LLC. Similarly, a power cost is also attached to every write to the LLC and every write to the memory. The cost of a write to the LLC is denoted by P(W-LLC) and the cost of a write to the memory is denoted by P(W-MEM). According to the embodiment, these costs may be programmed and adjusted based on the memory type, processor node, frequency, etc. to accommodate for existing and future hardware configurations. The predictor works by tracking the power costs associated with reads and writes to a sample set of cache lines (i.e., the observer set) and using the tracked power costs as a proxy for determining whether the redundant write detection mechanism is actually saving or wasting power.

On every write-back request to the observer set of cache lines, a power cost function is increased by P(R-LLC) for a read to obtain a cache line from the LLC. Then, if the write-back request is determined to be redundant and a write to the LLC is thus dropped, the power function is decremented by P(W-LLC) to account to the power saved from the dropped write. Furthermore, if the dropped redundant write to the LLC also saved a redundant write to the memory, the power cost function is further decremented by P(W-MEM). This is determined by tracking the cache lines that were dropped as redundant writes and see whether their corresponding copy in the LLC, when later evicted, would have been written into memory if not for the redundant write detection. According to an embodiment, a note is made by the predictor to indicate which cache lines were saved from a redundant write to the LLC. In one embodiment, this is performed by setting a bit in the corresponding cache line in the LLC. This bit is only required for the cache lines that are in the observer set and hence incurs only a small area addition. When these cache lines are later evicted from the LLC, the bit is checked to determine whether each of these cache lines was prevented from being marked (M)odified by the detection mechanism. If so, then a write to the memory is also saved. Accordingly, the cost function is further decreased by P(W-MEM). In summary, the total power consumed or saved can be represented by the following formula:

Total power consumed=P(R-LLC)−A %*P(W-LLC)−B %*P(W-MEM)

where A % is the percentage of overall writes to the LLC that were redundant and B % is the percentage of these redundant writes that would have created a redundant write to memory but for the detection mechanism. If total power consumed is greater than zero, then the detection mechanism is consuming more power than it saves. Accordingly, the detection mechanism should be throttled or deactivated. On the other hand, if total power consumed is less than zero, indicating a net power saving, the detection mechanism should remain active.

According to an embodiment, additional considerations are taken into account for determining if the redundant write detection mechanism is really creating a performance benefit. In one embodiment, the predictor may further monitor the demand on memory bandwidth. For example, the total memory bandwidth utilized can be calculated by the following equation:

Total Memory Bandwidth Used=Total LLC read misses+Total LLC dirty evictions

Each LLC read miss will result in the LLC reading the cache line from the memory, resulting in a memory read. On the other hand, each LLC dirty eviction will result in a cache line being saved to memory resulting in a memory write. Thus, the total memory bandwidth used is the sum of memory reads and writes caused by LLC read misses and dirty evictions. Now if the predictor determines that the total memory bandwidth used is significantly less than the total memory bandwidth available, the predictor may deactivate the redundant write detection mechanism. For instance, a memory usage ratio, M, may be calculated by:

$$M = \frac{Total Memory Bandwidth Used}{Total Memory Bandwidth Available}$$

The predictor may deactivate the redundant write detection mechanism if the memory usage ratio, M, is less than a specified threshold. What this means is that even though the detection mechanism may be reducing the number of memory by reducing the number of dirty evictions from the LLC, this saving in memory bandwidth has no practical benefit as the saved memory bandwidth is not being utilized by memory reads. In these scenarios, there is no reason to continue detecting redundant writes to the LLC.

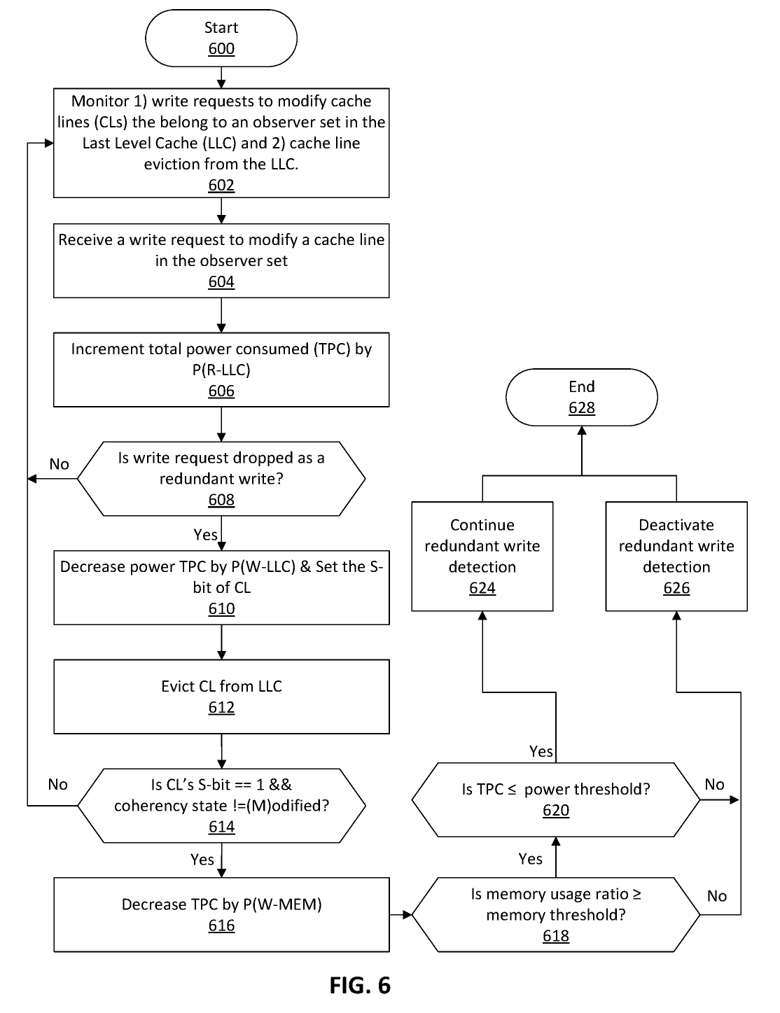

FIG. 6 illustrates a method for determining whether or not to continue detecting for redundant writes to the LLC according to an embodiment. The method can be implemented by the predictor or as part of a prediction mechanism. The method is based on tracking the total power consumed by writes to a certain set of cache lines (i.e., the observer set) in the LLC. According to an embodiment, the predictor or prediction mechanism continuously tracks the power consumed and saved by the redundant write detection mechanism, for writes to an observer set. The observer set contains a small number of cache lines that may be specifically selected or randomly chosen. In one embodiment, the redundant write detection mechanism is active by default. According to another embodiment, the redundant write detection mechanism, if deactivate, automatically turns itself on after a pre-determined amount of time has elapsed.

According to FIG. 6, the method begins at block 600. At block 602, the predictor monitors a set of cache lines in the LLC (i.e., the observer set) for requests to write to these cache lines. At block 604, a write request is received by the LLC or its cache agent/controller to modify a cache line in the observer set. In an embodiment, the write request is a write back request originated from a core. In another embodiment, the write request is triggered by the eviction of a cache line from another cache, such as from the L2 cache. At block 606, the total power consumed by the redundant write detection mechanism is increased by P(R-LLC). Since the redundant write detection mechanism is on by default, the write request is processed by the mechanism according to the method discussed above in FIG. 5. A determination is made at block 608 on whether the write request was dropped as a redundant write by the redundant write detection mechanism. If the write request was not dropped, thus indicating that new data was to be written into the LLC, the method returns to block 602 to continue monitoring write requests to cache lines in the observer set. This also means that the tag lookup/cache line read performed by the detection mechanism was performed without a corresponding power saving. However, if at block 608 the write request was dropped as a redundant write to the LLC, the total power consumed by the redundant write detection mechanism is decreased by P(W-LLC), at block 610, to account for the power saved from not having to perform a redundant write to the LLC. In addition, an S-bit in the corresponding cache line in in the observer set of the LLC is set. The S-bit is used to indicate that the cache line was “saved” by the redundant write detection mechanism from being modified by a redundant write. While this S-bit requires additional area in the cache line and the write to it consumes power, such area and power requirements are relatively insignificant, because the number of cache lines in the observer set is small compared to the size of the cache. Some time thereafter, the cache line that was saved from redundant write will be evicted from the LLC, at block 612. At block 614, the S-bit and coherency state of the evicted cache line is examined. If the cache line has not been updated by another write since it was saved from the redundant write, the cache line's S-bit would be set (i.e., S-bit=1) and its coherency state would not be (M)odified. Accordingly, the cache line would not need to be written back into the memory. What this means is that the redundant write detection mechanism not only saved a redundant write to the LLC, it also saved a redundant write to the memory. To account for this saving, the total power consumed by the redundant write detection mechanism is decreased by P(W-MEM), as illustrated by block 616.

Next, at block 618, a decision is made on whether the memory usage ratio is greater or equal to a memory threshold. As previously noted, the memory usage ratio is determined by dividing the total memory bandwidth used to perform memory reads and writes, by the total memory bandwidth available. If the memory usage ratio is less than a predetermined threshold, it signals that the memory bandwidth saved by the redundant write detection mechanism is not being utilized by other memory operations due to an overall low memory bandwidth demand. Accordingly, the redundant write detection mechanism is deactivated at block 626 to save power. On the other hand, if the memory usage ratio is greater than the predetermined threshold, then at block 620, the total power consumed by the redundant write detection mechanism is checked against a power threshold. If the total power consumed is less than or equal to the power threshold, then the redundant write detection mechanism is left to continue operating at block 624. However, if the total power consumed is greater than the power threshold, then the redundant write detection mechanism is deactivated at block 626. The method ends at block 628. According to an embodiment, the predictor periodically checks the state of the redundant write detection mechanism to see whether it is active. If the detection mechanism has not been active for a predetermined amount of time, the predictor automatically activates the mechanism to check for redundant writes.

A certain embodiment of a system includes: a plurality of processors; a memory coupled to one or more of the plurality of processors; a cache coupled to the memory such that a dirty cache line evicted from the cache is written to the memory; and a redundant write detection circuitry coupled to the cache, the redundant write detection circuitry to control write access to the cache based on a redundancy check of data to be written to the cache. The cache may be a Last Level Cache (LLC) or a Level 3 (L3) cache. The redundancy check may include: detecting a write request comprising an address corresponding to a first cache line in the cache; responsive to the detection, copying a first data of the first cache line from the cache to a buffer; receiving a second data corresponding to the write request and responsively comparing the second data to the first data in the buffer; replacing the first data in the buffer with the second data responsive to a determination that the first data in the buffer is different than the second data; and removing the first data from the buffer responsive to a determination that the first data in the buffer is same as the second data. The write request may be initiated by a write back request from a processor core or by a cache line eviction from a second cache. The redundancy check may further include discarding the second data responsive to the determination that the first data in the buffer is same as the second data. The redundancy check may further include writing the second data from the buffer to the first cache line in the cache responsive to the determination that the first data in the buffer is different than the second data. Writing the second data from the buffer to the first cache line in the cache may include setting a coherency state of the first cache line to (M)odified. The system may further include a first predictor circuitry to deactivate the redundant write detection circuitry responsive to a determination that power consumed by the redundancy check is greater than power saved by the redundancy check. The power consumed by the redundancy check may be based on a number of accesses made to the cache resulting from performing the redundancy check. The power saved by the redundancy check may be based on reductions in write accesses to the cache and to the memory resulting from performing the redundancy check. The system may also include a second predictor circuitry to deactivate the redundant write detection circuitry responsive to a determination that memory bandwidth saved resulting from performing the redundancy check is not being utilized by memory reads.

An embodiment of a method includes: detecting a write request comprising an address corresponding to a first cache line in a cache; responsive to the detection, copying a first data of the first cache line from the cache to a buffer; receiving a second data corresponding to the write request and responsively comparing the second data to a first data in the buffer; replacing the first data in the buffer with the second data responsive to a determination that the first data in the buffer is different than the second data; and removing the first data from the buffer responsive to a determination that the first data in the buffer is same as the second data. The cache may be a Last Level Cache (LLC) or a Level 3 (L3) cache.

The write request may be initiated by a write back request from a processor core or by a cache line eviction from a second cache. The method may further include discarding the second data responsive to the determination that the first data in the buffer is same as the second data. The method may further include writing the second data from the buffer to the first cache line in the cache responsive to the determination that the first data in the buffer is different than the second data. The writing of the second data from the buffer to the first cache line in the cache may further include setting a coherency state of the first cache line to (M)odified. The method may further include determining a power consumption for locating the first cache line in the cache and copying the first data of the first cache line from the cache to the buffer. the method may also include determining a power saving resulting from not having to write the copy of first data from the buffer to the cache as a result of removing the first data from the buffer.

An embodiment includes a processor coupled to a memory, the processor includes: a plurality of cores, at least one shared cache to be shared among two or more of the plurality of cores, such that a dirty cache line evicted from the cache is written to the memory; and a redundant write detection circuitry coupled to the cache, the redundant write detection circuitry to control write access to the cache based on a redundancy check of data to be written to the cache. The cache may be a Last Level Cache (LLC) or a Level 3 (L3) cache. The redundancy check may include: detecting a write request comprising an address corresponding to a first cache line in the cache; responsive to the detection, copying a first data of the first cache line from the cache to a buffer; receiving a second data corresponding to the write request and responsively comparing the second data to a first data in the buffer; replacing the first data in the buffer with the second data responsive to a determination that the first data in the buffer is different than the second data; and removing the first data from the buffer responsive to a determination that the first data in the buffer is same as the second data. The write request may be initiated by a write back request from a processor core or by a cache line eviction from a second cache. The redundancy check may further include discarding the second data responsive to the determination that the first data in the buffer is same as the second data. The redundancy check may further include writing the second data from the buffer to the first cache line in the cache responsive to the determination that the first data in the buffer is different than the second data. Writing the second data from the buffer to the first cache line in the cache may include setting a coherency state of the first cache line to (M)odified. The processor may further include a first predictor circuitry to deactivate the redundant write detection circuitry responsive to a determination that power consumed by the redundancy check is greater than power saved by the redundancy check. The power consumed by the redundancy check may be based on a number of accesses made to the cache resulting from performing the redundancy check. The power saved by the redundancy check may be based on reductions in write accesses to the cache and to the memory resulting from performing the redundancy check. The processor may also include a second predictor circuitry to deactivate the redundant write detection circuitry responsive to a determination that memory bandwidth saved resulting from performing the redundancy check is not being utilized by memory reads.

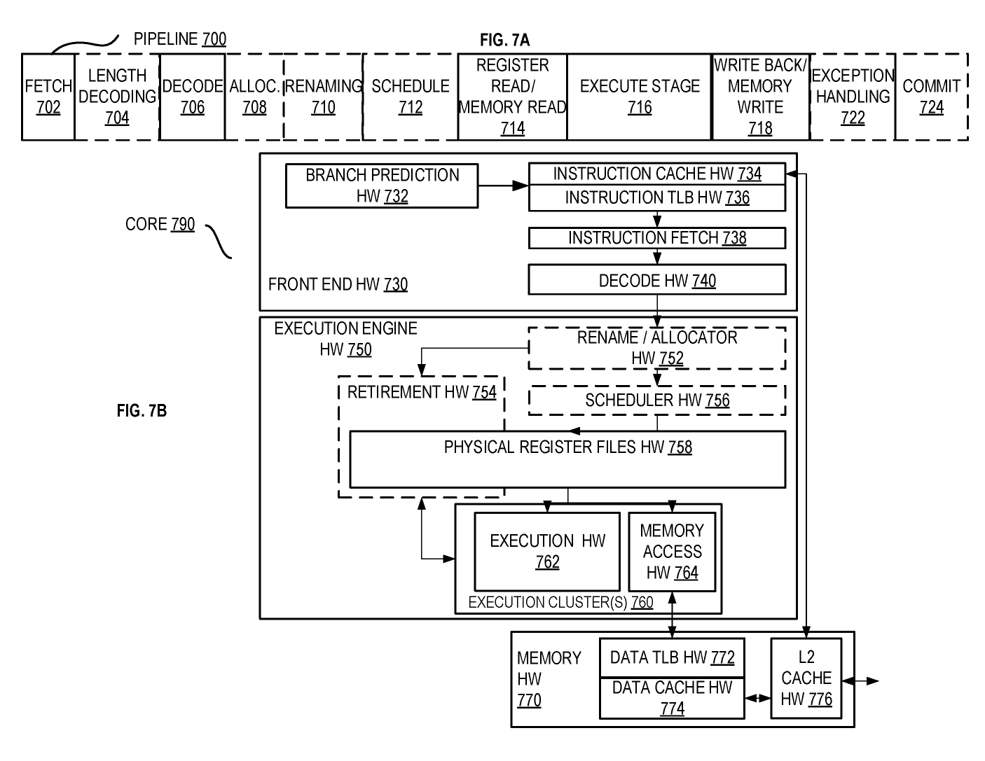

FIG. 7A is a block diagram illustrating both an exemplary in-order pipeline and an exemplary register renaming, out-of-order issue/execution pipeline according to embodiments of the invention. FIG. 7B is a block diagram illustrating both an exemplary embodiment of an in-order architecture core and an exemplary register renaming, out-of-order issue/execution architecture core to be included in a processor according to embodiments of the invention. The solid lined boxes in FIGS. 7A-B illustrate the in-order pipeline and in-order core, while the optional addition of the dashed lined boxes illustrates the register renaming, out-of-order issue/execution pipeline and core. Given that the in-order aspect is a subset of the out-of-order aspect, the out-of-order aspect will be described.

In FIG. 7A, a processor pipeline 700 includes a fetch stage 702, a length decode stage 704, a decode stage 706, an allocation stage 708, a renaming stage 710, a scheduling (also known as a dispatch or issue) stage 712, a register read/memory read stage 714, an execute stage 716, a write back/memory write stage 718, an exception handling stage 722, and a commit stage 724.

FIG. 7B shows processor core 790 including a front end hardware 730 coupled to an execution engine hardware 750, and both are coupled to a memory hardware 770. The core 790 may be a reduced instruction set computing (RISC) core, a complex instruction set computing (CISC) core, a very long instruction word (VLIW) core, or a hybrid or alternative core type. As yet another option, the core 790 may be a special-purpose core, such as, for example, a network or communication core, compression engine, coprocessor core, general purpose computing graphics processing unit (GPGPU) core, graphics core, or the like.

The front end hardware 730 includes a branch prediction hardware 732 coupled to an instruction cache hardware 734, which is coupled to an instruction translation lookaside buffer (TLB) 736, which is coupled to an instruction fetch hardware 738, which is coupled to a decode hardware 740. The decode hardware 740 (or decoder) may decode instructions, and generate as an output one or more micro-operations, micro-code entry points, microinstructions, other instructions, or other control signals, which are decoded from, or which otherwise reflect, or are derived from, the original instructions. The decode hardware 740 may be implemented using various different mechanisms. Examples of suitable mechanisms include, but are not limited to, look-up tables, hardware implementations, programmable logic arrays (PLAs), microcode read only memories (ROMs), etc. In one embodiment, the core 790 includes a microcode ROM or other medium that stores microcode for certain macroinstructions (e.g., in decode hardware 740 or otherwise within the front end hardware 730). The decode hardware 740 is coupled to a rename/allocator hardware 752 in the execution engine hardware 750.

The execution engine hardware 750 includes the rename/allocator hardware 752 coupled to a retirement hardware 754 and a set of one or more scheduler hardware 756. The scheduler hardware 756 represents any number of different schedulers, including reservations stations, central instruction window, etc. The scheduler hardware 756 is coupled to the physical register file(s) hardware 758. Each of the physical register file(s) hardware 758 represents one or more physical register files, different ones of which store one or more different data types, such as scalar integer, scalar floating point, packed integer, packed floating point, vector integer, vector floating point, status (e.g., an instruction pointer that is the address of the next instruction to be executed), etc. In one embodiment, the physical register file(s) hardware 758 comprises a vector registers hardware, a write mask registers hardware, and a scalar registers hardware. These register hardware may provide architectural vector registers, vector mask registers, and general purpose registers. The physical register file(s) hardware 758 is overlapped by the retirement hardware 754 to illustrate various ways in which register renaming and out-of-order execution may be implemented (e.g., using a reorder buffer(s) and a retirement register file(s); using a future file(s), a history buffer(s), and a retirement register file(s); using a register maps and a pool of registers; etc.). The retirement hardware 754 and the physical register file(s) hardware 758 are coupled to the execution cluster(s) 760. The execution cluster(s) 760 includes a set of one or more execution hardware 762 and a set of one or more memory access hardware 764. The execution hardware 762 may perform various operations (e.g., shifts, addition, subtraction, multiplication) and on various types of data (e.g., scalar floating point, packed integer, packed floating point, vector integer, vector floating point). While some embodiments may include a number of execution hardware dedicated to specific functions or sets of functions, other embodiments may include only one execution hardware or multiple execution hardware that all perform all functions. The scheduler hardware 756, physical register file(s) hardware 758, and execution cluster(s) 760 are shown as being possibly plural because certain embodiments create separate pipelines for certain types of data/operations (e.g., a scalar integer pipeline, a scalar floating point/packed integer/packed floating point/vector integer/vector floating point pipeline, and/or a memory access pipeline that each have their own scheduler hardware, physical register file(s) hardware, and/or execution cluster—and in the case of a separate memory access pipeline, certain embodiments are implemented in which only the execution cluster of this pipeline has the memory access hardware 764). It should also be understood that where separate pipelines are used, one or more of these pipelines may be out-of-order issue/execution and the rest in-order.

The set of memory access hardware 764 is coupled to the memory hardware 770, which includes a data TLB hardware 772 coupled to a data cache hardware 774 coupled to a level 2 (L2) cache hardware 776. In one exemplary embodiment, the memory access hardware 764 may include a load hardware, a store address hardware, and a store data hardware, each of which is coupled to the data TLB hardware 772 in the memory hardware 770. The instruction cache hardware 734 is further coupled to a level 2 (L2) cache hardware 776 in the memory hardware 770. The L2 cache hardware 776 is coupled to one or more other levels of cache and eventually to a main memory.

By way of example, the exemplary register renaming, out-of-order issue/execution core architecture may implement the pipeline 700 as follows: 1) the instruction fetch 738 performs the fetch and length decoding stages 702 and 704; 2) the decode hardware 740 performs the decode stage 706; 3) the rename/allocator hardware 752 performs the allocation stage 708 and renaming stage 710; 4) the scheduler hardware 756 performs the schedule stage 712; 5) the physical register file(s) hardware 758 and the memory hardware 770 perform the register read/memory read stage 714; the execution cluster 760 perform the execute stage 716; 6) the memory hardware 770 and the physical register file(s) hardware 758 perform the write back/memory write stage 718; 7) various hardware may be involved in the exception handling stage 722; and 8) the retirement hardware 754 and the physical register file(s) hardware 758 perform the commit stage 724.

The core 790 may support one or more instructions sets (e.g., the ×86 instruction set (with some extensions that have been added with newer versions); the MIPS instruction set of MIPS Technologies of Sunnyvale, Calif.; the ARM instruction set (with optional additional extensions such as NEON) of ARM Holdings of Sunnyvale, Calif.), including the instruction(s) described herein. In one embodiment, the core 790 includes logic to support a packed data instruction set extension (e.g., AVX1, AVX2, and/or some form of the generic vector friendly instruction format (U=0 and/or U=1), described below), thereby allowing the operations used by many multimedia applications to be performed using packed data.

It should be understood that the core may support multithreading (executing two or more parallel sets of operations or threads), and may do so in a variety of ways including time sliced multithreading, simultaneous multithreading (where a single physical core provides a logical core for each of the threads that physical core is simultaneously multithreading), or a combination thereof (e.g., time sliced fetching and decoding and simultaneous multithreading thereafter such as in the Intel® Hyperthreading technology).

While register renaming is described in the context of out-of-order execution, it should be understood that register renaming may be used in an in-order architecture. While the illustrated embodiment of the processor also includes separate instruction and data cache hardware 734/774 and a shared L2 cache hardware 776, alternative embodiments may have a single internal cache for both instructions and data, such as, for example, a Level 1 (L1) internal cache, or multiple levels of internal cache. In some embodiments, the system may include a combination of an internal cache and an external cache that is external to the core and/or the processor. Alternatively, all of the cache may be external to the core and/or the processor.

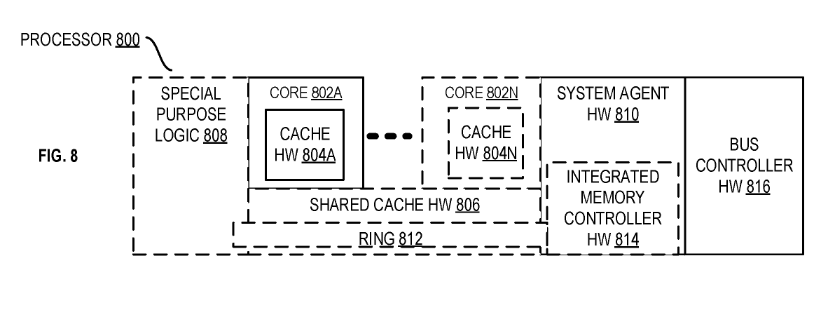

FIG. 8 is a block diagram of a processor 800 that may have more than one core, may have an integrated memory controller, and may have integrated graphics according to embodiments of the invention. The solid lined boxes in FIG. 8 illustrate a processor 800 with a single core 802A, a system agent 810, a set of one or more bus controller hardware 816, while the optional addition of the dashed lined boxes illustrates an alternative processor 800 with multiple cores 802A-N, a set of one or more integrated memory controller hardware 814 in the system agent hardware 810, and special purpose logic 808.

Thus, different implementations of the processor 800 may include: 1) a CPU with the special purpose logic 808 being integrated graphics and/or scientific (throughput) logic (which may include one or more cores), and the cores 802A-N being one or more general purpose cores (e.g., general purpose in-order cores, general purpose out-of-order cores, a combination of the two); 2) a coprocessor with the cores 802A-N being a large number of special purpose cores intended primarily for graphics and/or scientific (throughput); and 3) a coprocessor with the cores 802A-N being a large number of general purpose in-order cores. Thus, the processor 800 may be a general-purpose processor, coprocessor or special-purpose processor, such as, for example, a network or communication processor, compression engine, graphics processor, GPGPU (general purpose graphics processing unit), a high-throughput many integrated core (MIC) coprocessor (including 30 or more cores), embedded processor, or the like. The processor may be implemented on one or more chips. The processor 800 may be a part of and/or may be implemented on one or more substrates using any of a number of process technologies, such as, for example, BiCMOS, CMOS, or NMOS.

The memory hierarchy includes one or more levels of cache within the cores, a set or one or more shared cache hardware 806, and external memory (not shown) coupled to the set of integrated memory controller hardware 814. The set of shared cache hardware 806 may include one or more mid-level caches, such as level 2 (L2), level 3 (L3), level 4 (L4), or other levels of cache, a last level cache (LLC), and/or combinations thereof. While in one embodiment a ring based interconnect hardware 812 interconnects the integrated graphics logic 808, the set of shared cache hardware 806, and the system agent hardware 810/integrated memory controller hardware 814, alternative embodiments may use any number of well-known techniques for interconnecting such hardware. In one embodiment, coherency is maintained between one or more cache hardware 806 and cores 802-A-N.

In some embodiments, one or more of the cores 802A-N are capable of multi-threading. The system agent 810 includes those components coordinating and operating cores 802A-N. The system agent hardware 810 may include for example a power control unit (PCU) and a display hardware. The PCU may be or include logic and components needed for regulating the power state of the cores 802A-N and the integrated graphics logic 808. The display hardware is for driving one or more externally connected displays.

The cores 802A-N may be homogenous or heterogeneous in terms of architecture instruction set; that is, two or more of the cores 802A-N may be capable of execution the same instruction set, while others may be capable of executing only a subset of that instruction set or a different instruction set. In one embodiment, the cores 802A-N are heterogeneous and include both the “small” cores and “big” cores described below.

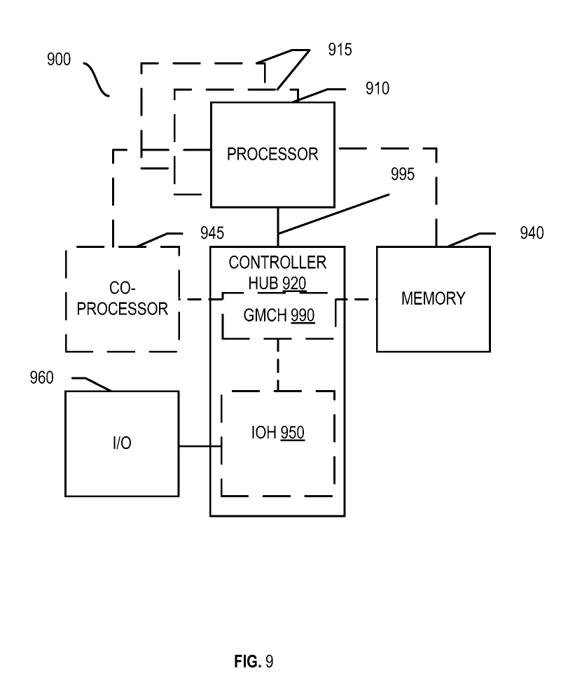

FIGS. 9-12 are block diagrams of exemplary computer architectures. Other system designs and configurations known in the arts for laptops, desktops, handheld PCs, personal digital assistants, engineering workstations, servers, network devices, network hubs, switches, embedded processors, digital signal processors (DSPs), graphics devices, video game devices, set-top boxes, micro controllers, cell phones, portable media players, hand held devices, and various other electronic devices, are also suitable. In general, a huge variety of systems or electronic devices capable of incorporating a processor and/or other execution logic as disclosed herein are generally suitable.

Referring now to FIG. 9, shown is a block diagram of a system 900 in accordance with one embodiment of the present invention. The system 900 may include one or more processors 910, 915, which are coupled to a controller hub 920. In one embodiment the controller hub 920 includes a graphics memory controller hub (GMCH) 990 and an Input/Output Hub (IOH) 950 (which may be on separate chips); the GMCH 990 includes memory and graphics controllers to which are coupled memory 940 and a coprocessor 945; the IOH 950 is couples input/output (I/O) devices 960 to the GMCH 990. Alternatively, one or both of the memory and graphics controllers are integrated within the processor (as described herein), the memory 940 and the coprocessor 945 are coupled directly to the processor 910, and the controller hub 920 in a single chip with the IOH 950.

The optional nature of additional processors 915 is denoted in FIG. 9 with broken lines. Each processor 910, 915 may include one or more of the processing cores described herein and may be some version of the processor 800.

The memory 940 may be, for example, dynamic random access memory (DRAM), phase change memory (PCM), or a combination of the two. For at least one embodiment, the controller hub 920 communicates with the processor(s) 910, 915 via a multi-drop bus, such as a frontside bus (FSB), point-to-point interface, or similar connection 995.

In one embodiment, the coprocessor 945 is a special-purpose processor, such as, for example, a high-throughput MIC processor, a network or communication processor, compression engine, graphics processor, GPGPU, embedded processor, or the like. In one embodiment, controller hub 920 may include an integrated graphics accelerator.

There can be a variety of differences between the physical resources 910, 915 in terms of a spectrum of metrics of merit including architectural, microarchitectural, thermal, power consumption characteristics, and the like.

In one embodiment, the processor 910 executes instructions that control data processing operations of a general type. Embedded within the instructions may be coprocessor instructions. The processor 910 recognizes these coprocessor instructions as being of a type that should be executed by the attached coprocessor 945. Accordingly, the processor 910 issues these coprocessor instructions (or control signals representing coprocessor instructions) on a coprocessor bus or other interconnect, to coprocessor 945. Coprocessor(s) 945 accept and execute the received coprocessor instructions.

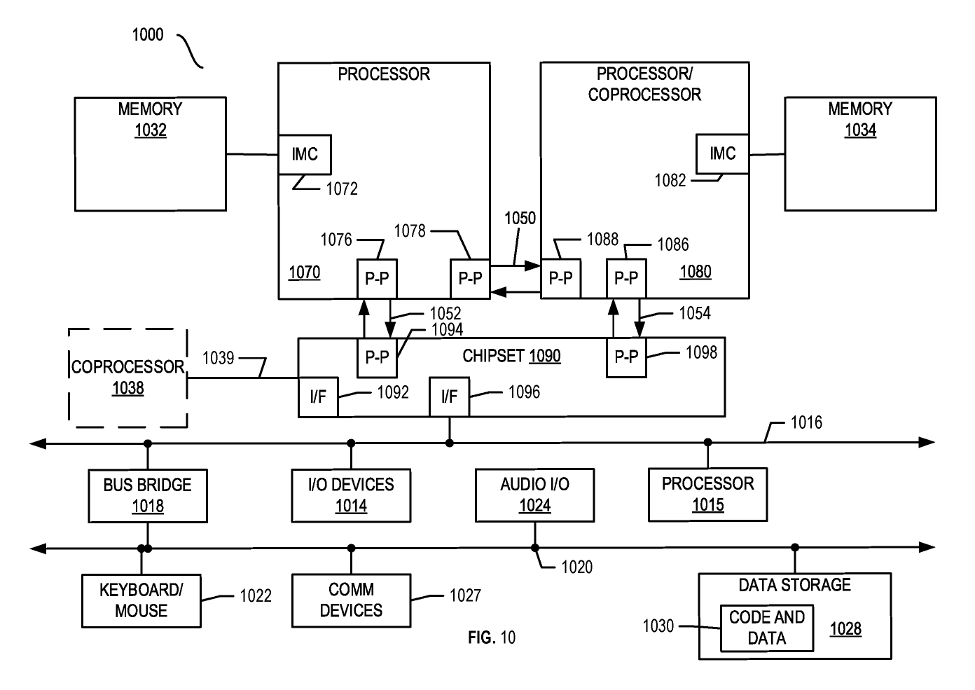

Referring now to FIG. 10, shown is a block diagram of a first more specific exemplary system 1000 in accordance with an embodiment of the present invention. As shown in FIG. 10, multiprocessor system 1000 is a point-to-point interconnect system, and includes a first processor 1070 and a second processor 1080 coupled via a point-to-point interconnect 1050. Each of processors 1070 and 1080 may be some version of the processor 800. In one embodiment of the invention, processors 1070 and 1080 are respectively processors 910 and 915, while coprocessor 1038 is coprocessor 945. In another embodiment, processors 1070 and 1080 are respectively processor 910 coprocessor 945.

Processors 1070 and 1080 are shown including integrated memory controller (IMC) hardware 1072 and 1082, respectively. Processor 1070 also includes as part of its bus controller hardware point-to-point (P-P) interfaces 1076 and 1078; similarly, second processor 1080 includes P-P interfaces 1086 and 1088. Processors 1070, 1080 may exchange information via a point-to-point (P-P) interface 1050 using P-P interface circuits 1078, 1088. As shown in FIG. 10, IMCs 1072 and 1082 couple the processors to respective memories, namely a memory 1032 and a memory 1034, which may be portions of main memory locally attached to the respective processors.

Processors 1070, 1080 may each exchange information with a chipset 1090 via individual P-P interfaces 1052, 1054 using point to point interface circuits 1076, 1094, 1086, 1098. Chipset 1090 may optionally exchange information with the coprocessor 1038 via a high-performance interface 1039. In one embodiment, the coprocessor 1038 is a special-purpose processor, such as, for example, a high-throughput MIC processor, a network or communication processor, compression engine, graphics processor, GPGPU, embedded processor, or the like.

A shared cache (not shown) may be included in either processor or outside of both processors, yet connected with the processors via P-P interconnect, such that either or both processors' local cache information may be stored in the shared cache if a processor is placed into a low power mode.

Chipset 1090 may be coupled to a first bus 1016 via an interface 1096. In one embodiment, first bus 1016 may be a Peripheral Component Interconnect (PCI) bus, or a bus such as a PCI Express bus or another third generation I/O interconnect bus, although the scope of the present invention is not so limited.

As shown in FIG. 10, various I/O devices 1014 may be coupled to first bus 1016, along with a bus bridge 1018 which couples first bus 1016 to a second bus 1020. In one embodiment, one or more additional processor(s) 1015, such as coprocessors, high-throughput MIC processors, GPGPU's, accelerators (such as, e.g., graphics accelerators or digital signal processing (DSP) hardware), field programmable gate arrays, or any other processor, are coupled to first bus 1016. In one embodiment, second bus 1020 may be a low pin count (LPC) bus. Various devices may be coupled to a second bus 1020 including, for example, a keyboard and/or mouse 1022, communication devices 1027 and a storage hardware 1028 such as a disk drive or other mass storage device which may include instructions/code and data 1030, in one embodiment. Further, an audio I/O 1024 may be coupled to the second bus 1020. Note that other architectures are possible. For example, instead of the point-to-point architecture of FIG. 10, a system may implement a multi-drop bus or other such architecture.

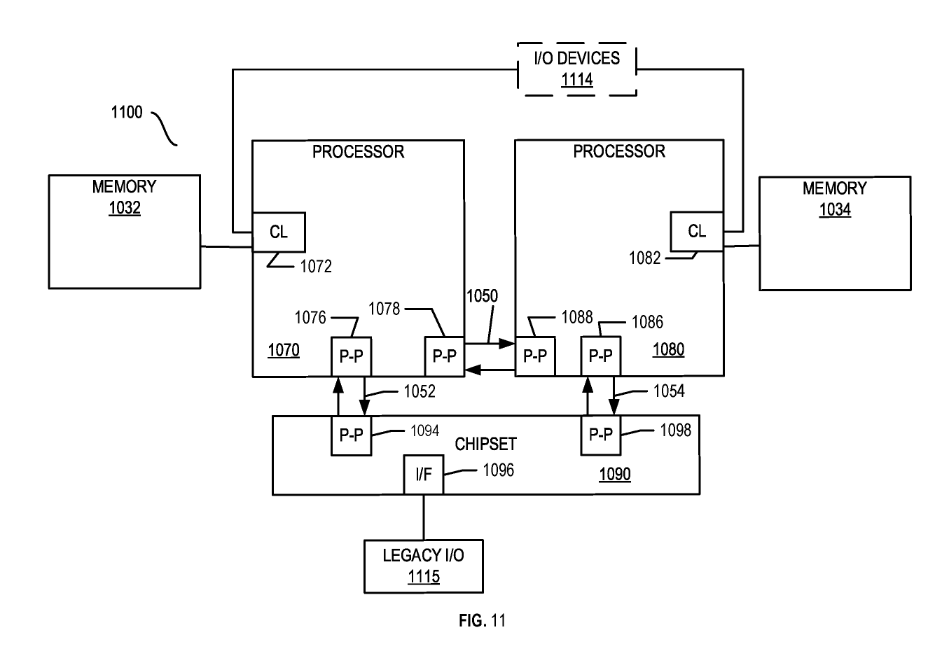

Referring now to FIG. 11, shown is a block diagram of a second more specific exemplary system 1100 in accordance with an embodiment of the present invention. Like elements in FIGS. 10 and 11 bear like reference numerals, and certain aspects of FIG. 10 have been omitted from FIG. 11 in order to avoid obscuring other aspects of FIG. 11.

FIG. 11 illustrates that the processors 1070, 1080 may include integrated memory and I/O control logic (“CL”) 1072 and 1082, respectively. Thus, the CL 1072, 1082 include integrated memory controller hardware and include I/O control logic. FIG. 11 illustrates that not only are the memories 1032, 1034 coupled to the CL 1072, 1082, but also that I/O devices 1114 are also coupled to the control logic 1072, 1082. Legacy I/O devices 1115 are coupled to the chipset 1090.

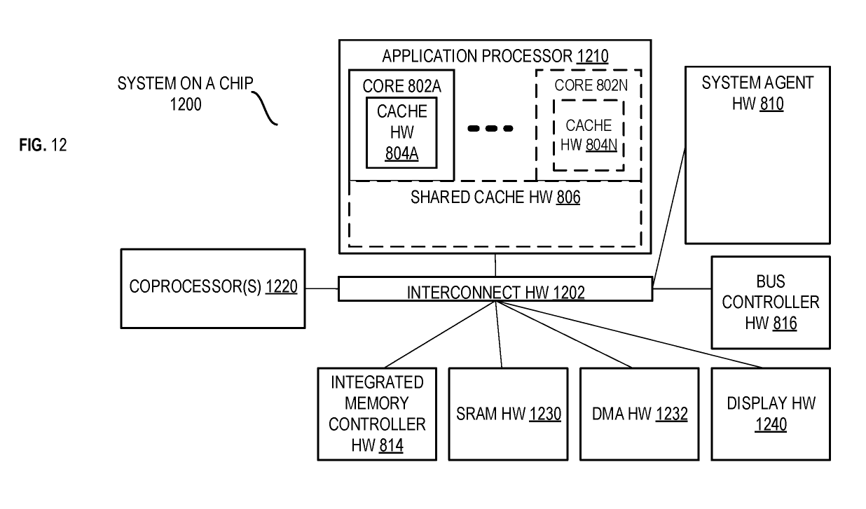

Referring now to FIG. 12, shown is a block diagram of a SoC 1200 in accordance with an embodiment of the present invention. Similar elements in FIG. 8 bear like reference numerals. Also, dashed lined boxes are optional features on more advanced SoCs. In FIG. 12, an interconnect hardware 1202 is coupled to: an application processor 1210 which includes a set of one or more cores 802A-N and shared cache hardware 806; a system agent hardware 810; a bus controller hardware 816; an integrated memory controller hardware 814; a set or one or more coprocessors 1220 which may include integrated graphics logic, an image processor, an audio processor, and a video processor; an static random access memory (SRAM) hardware 1230; a direct memory access (DMA) hardware 1232; and a display hardware 1240 for coupling to one or more external displays. In one embodiment, the coprocessor(s) 1220 include a special-purpose processor, such as, for example, a network or communication processor, compression engine, GPGPU, a high-throughput MIC processor, embedded processor, or the like.

Embodiments of the mechanisms disclosed herein may be implemented in hardware, software, firmware, or a combination of such implementation approaches. Embodiments of the invention may be implemented as computer programs or program code executing on programmable systems comprising at least one processor, a storage system (including volatile and non-volatile memory and/or storage elements), at least one input device, and at least one output device.

Program code, such as code 1030 illustrated in FIG. 10, may be applied to input instructions to perform the functions described herein and generate output information. The output information may be applied to one or more output devices, in known fashion. For purposes of this application, a processing system includes any system that has a processor, such as, for example; a digital signal processor (DSP), a microcontroller, an application specific integrated circuit (ASIC), or a microprocessor.

The program code may be implemented in a high level procedural or object oriented programming language to communicate with a processing system. The program code may also be implemented in assembly or machine language, if desired. In fact, the mechanisms described herein are not limited in scope to any particular programming language. In any case, the language may be a compiled or interpreted language.

One or more aspects of at least one embodiment may be implemented by representative instructions stored on a machine-readable medium which represents various logic within the processor, which when read by a machine causes the machine to fabricate logic to perform the techniques described herein. Such representations, known as “IP cores” may be stored on a tangible, machine readable medium and supplied to various customers or manufacturing facilities to load into the fabrication machines that actually make the logic or processor.

Such machine-readable storage media may include, without limitation, non-transitory, tangible arrangements of articles manufactured or formed by a machine or device, including storage media such as hard disks, any other type of disk including floppy disks, optical disks, compact disk read-only memories (CD-ROMs), compact disk rewritable's (CD-RWs), and magneto-optical disks, semiconductor devices such as read-only memories (ROMs), random access memories (RAMs) such as dynamic random access memories (DRAMs), static random access memories (SRAMs), erasable programmable read-only memories (EPROMs), flash memories, electrically erasable programmable read-only memories (EEPROMs), phase change memory (PCM), magnetic or optical cards, or any other type of media suitable for storing electronic instructions.

Accordingly, embodiments of the invention also include non-transitory, tangible machine-readable media containing instructions or containing design data, such as Hardware Description Language (HDL), which defines structures, circuits, apparatuses, processors and/or system features described herein. Such embodiments may also be referred to as program products.

In some cases, an instruction converter may be used to convert an instruction from a source instruction set to a target instruction set. For example, the instruction converter may translate (e.g., using static binary translation, dynamic binary translation including dynamic compilation), morph, emulate, or otherwise convert an instruction to one or more other instructions to be processed by the core. The instruction converter may be implemented in software, hardware, firmware, or a combination thereof. The instruction converter may be on processor, off processor, or part on and part off processor.

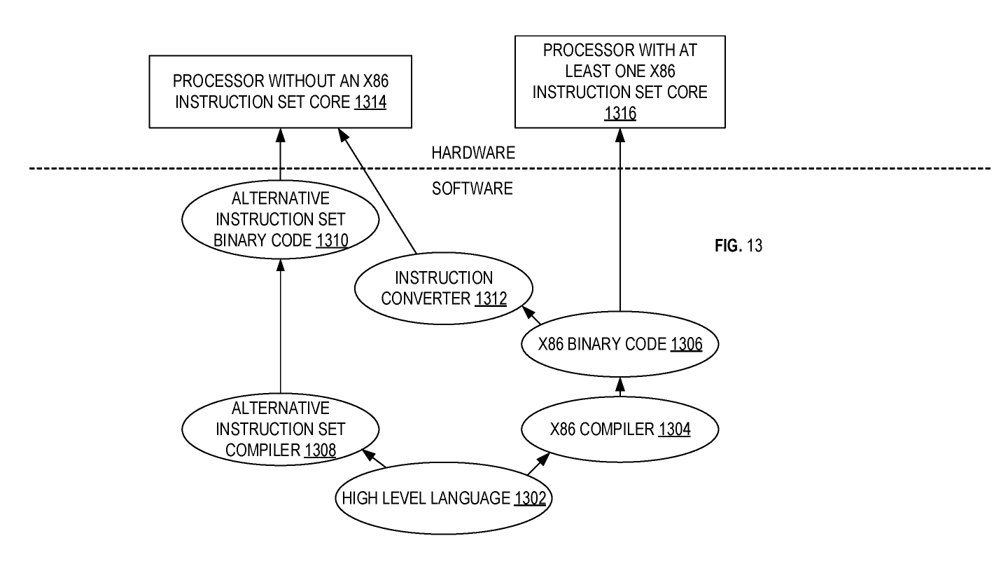

FIG. 13 is a block diagram contrasting the use of a software instruction converter to convert binary instructions in a source instruction set to binary instructions in a target instruction set according to embodiments of the invention. In the illustrated embodiment, the instruction converter is a software instruction converter, although alternatively the instruction converter may be implemented in software, firmware, hardware, or various combinations thereof. FIG. 13 shows a program in a high level language 1302 may be compiled using an ×86 compiler 1304 to generate ×86 binary code 1306 that may be natively executed by a processor with at least one ×86 instruction set core 1316. The processor with at least one ×86 instruction set core 1316 represents any processor that can perform substantially the same functions as an Intel processor with at least one ×86 instruction set core by compatibly executing or otherwise processing (1) a substantial portion of the instruction set of the Intel ×86 instruction set core or (2) object code versions of applications or other software targeted to run on an Intel processor with at least one ×86 instruction set core, in order to achieve substantially the same result as an Intel processor with at least one ×86 instruction set core. The ×86 compiler 1304 represents a compiler that is operable to generate ×86 binary code 1306 (e.g., object code) that can, with or without additional linkage processing, be executed on the processor with at least one ×86 instruction set core 1316. Similarly, FIG. 13 shows the program in the high level language 1302 may be compiled using an alternative instruction set compiler 1308 to generate alternative instruction set binary code 1310 that may be natively executed by a processor without at least one ×86 instruction set core 1314 (e.g., a processor with cores that execute the MIPS instruction set of MIPS Technologies of Sunnyvale, Calif. and/or that execute the ARM instruction set of ARM Holdings of Sunnyvale, Calif.). The instruction converter 1312 is used to convert the ×86 binary code 1306 into code that may be natively executed by the processor without an ×86 instruction set core 1314. This converted code is not likely to be the same as the alternative instruction set binary code 1310 because an instruction converter capable of this is difficult to make; however, the converted code will accomplish the general operation and be made up of instructions from the alternative instruction set. Thus, the instruction converter 1312 represents software, firmware, hardware, or a combination thereof that, through emulation, simulation or any other process, allows a processor or other electronic device that does not have an ×86 instruction set processor or core to execute the ×86 binary code 1306.

Although some embodiments have been described in reference to particular implementations, other implementations are possible according to some embodiments. Additionally, the arrangement and/or order of elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

In the description and claims, the terms “coupled” and “connected,” along with their derivatives, may be used. It should be understood that these terms are not intended as synonyms for each other. Rather, in particular embodiments, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An embodiment is an implementation or example of the inventions. Reference in the specification to “an embodiment,” “one embodiment,” “some embodiments,” or “other embodiments” means that a particular feature, structure, or characteristic described in connection with the embodiments is included in at least some embodiments, but not necessarily all embodiments, of the inventions. The various appearances “an embodiment,” “one embodiment,” or “some embodiments” are not necessarily all referring to the same embodiments.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

The above description of illustrated embodiments of the invention, including what is described in the Abstract, is not intended to be exhaustive or to limit the invention to the precise forms disclosed. While specific embodiments of, and examples for, the invention are described herein for illustrative purposes, various equivalent modifications are possible within the scope of the invention, as those skilled in the relevant art will recognize.

These modifications can be made to the invention in light of the above detailed description. The terms used in the following claims should not be construed to limit the invention to the specific embodiments disclosed in the specification and the drawings. Rather, the scope of the invention is to be determined entirely by the following claims, which are to be construed in accordance with established doctrines of claim interpretation.

### EXAMPLES

Example 1 provides a system including a plurality of processors, a memory coupled to one or more of the plurality of processors, a cache coupled to the memory such that a dirty cache line evicted from the cache is written to the memory, and a redundant write detection circuitry coupled to the cache such that the redundant write detection circuitry controls write access to the cache based on a redundancy check of data to be written to the cache.

Example 2 includes the substance of example 1. In this example, the cache is a Last Level Cache (LLC).

Example 3 includes the substance of example 1. In this example, the cache is a Level 3 (L3) cache.

Example 4 includes the substance of any one of examples 1-3. In this example, the redundancy check includes detecting a write request comprising an address corresponding to a first cache line in the cache, copying a first data of the first cache line from the cache to a buffer in response to the detection, receiving a second data corresponding to the write request and responsively comparing the second data to the first data in the buffer, replacing the first data in the buffer with the second data responsive to a determination that the first data in the buffer is different than the second data; and removing the first data from the buffer responsive to a determination that the first data in the buffer is same as the second data.

Example 5 includes the substance of example 4. In this example the write request is initiated by a write back request from a processor core.

Example 6 includes the substance of any one of examples 4-5. In this example, the write request is initiated by a cache line eviction from a second cache.

Example 7 includes the substance of any one of examples 4-6. In this example, the redundancy check further includes discarding the second data responsive to the determination that the first data in the buffer is same as the second data.

Example 8 includes the substance of any one of examples 4-7. In this example, the redundancy check further includes writing the second data from the buffer to the first cache line in the cache responsive to the determination that the first data in the buffer is different than the second data.

Example 9 includes the substance of example 8. In this example, the second data from the buffer to the first cache line in the cache further includes setting a coherency state of the first cache line to (M)odified.

Example 10 includes the substance of any one of examples 1-9, further including a first predictor circuitry to deactivate the redundant write detection circuitry responsive to a determination that power consumed by the redundancy check is greater than power saved by the redundancy check.

Example 11 includes the substance of example 10. In this example, the power consumed by the redundancy check is based on a number of accesses made to the cache resulting from performing the redundancy check.

Example 12 includes the substance of any one of examples 10-11. In this example, the power saved by the redundancy check is based on reductions in write accesses to the cache and to the memory resulting from performing the redundancy check.

Example 13 includes the substance of any one of examples 1-12, further including a second predictor circuitry to deactivate the redundant write detection circuitry responsive to a determination that memory bandwidth saved resulting from performing the redundancy check is not being utilized by memory reads.

Example 14 provides a method that includes detecting a write request comprising an address corresponding to a first cache line in a cache, copying a first data of the first cache line from the cache to a buffer in response to the detection, receiving a second data corresponding to the write request and responsively comparing the second data to the first data in the buffer, replacing the first data in the buffer with the second data responsive to a determination that the first data in the buffer is different than the second data, and removing the first data from the buffer responsive to a determination that the first data in the buffer is same as the second data.

Example 15 includes the substance of example 14. In this example, the cache is a Last Level Cache (LLC).

Example 16 includes the substance of example 14. In this example, the cache is a Level 3 (L3) cache.

Example 17 includes the substance of any one of examples 14-16. In this example, the write request is initiated by a write back request from a processor core.

Example 18 includes the substance of any one of examples 14-17. In this example, the write request is initiated by a cache line eviction from a second cache.

Example 19 includes the substance of any one of examples 14-18, further including discarding the second data responsive to the determination that the first data in the buffer is same as the second data.

Example 20 includes the substance of any one of examples 14-19, further including writing the second data from the buffer to the first cache line in the cache responsive to the determination that the first data in the buffer is different than the second data.

Example 21 includes the substance of example 20. In this example, the writing of the second data from the buffer to the first cache line in the cache further includes setting a coherency state of the first cache line to (M)odified.

Example 22 includes the substance of any one of examples 14-21, further including determining a power consumption for locating the first cache line in the cache and copying the first data of the first cache line from the cache to the buffer.

Example 23 includes the substance of any one of examples 14-22, further including determining a power saving resulting from not having to write the first data from the buffer to the cache as a result of removing the first data from the buffer.

Example 24 provides a processor coupled to a memory. The processor may also optionally include a plurality of cores, at least one shared cache to be shared among two or more of the plurality of cores, such that a dirty cache line evicted from the cache is written to the memory, and a redundant write detection circuitry coupled to the cache, the redundant write detection circuitry to control write access to the cache based on a redundancy check of data to be written to the cache.

Example 25 include the substance of example 24. In this example, the cache is a Last Level Cache (LLC).

Example 26 includes the substance of example 24. In this example, the cache is a Level 3 (L3) cache.

Example 27 includes the substance of any one of examples 24-26. In this example, the redundancy check further includes detecting a write request comprising an address corresponding to a first cache line in the cache, copying a first data of the first cache line from the cache to a buffer in response to the detection, receiving a second data corresponding to the write request and responsively comparing the second data to the first data in the buffer, replacing the first data in the buffer with the second data responsive to a determination that the first data in the buffer is different than the second data, and removing the first data from the buffer responsive to a determination that the first data in the buffer is same as the second data.

Example 28 includes the substance of any one of example 27. In this example, the write request is initiated by a write back request from a processor core.

Example 29 includes the substance of any one of examples 27-28. In this example, the write request is initiated by a cache line eviction from a second cache.

Example 30 includes the substance of any one of examples 27-29. In this example, the redundancy check further includes discarding the second data responsive to the determination that the first data in the buffer is same as the second data.

Example 31 includes the substance of any one of examples 27-30. In this example, the redundancy check further includes writing the second data from the buffer to the first cache line in the cache responsive to the determination that the first data in the buffer is different than the second data.

Example 32 includes the substance of example 31. In this example, the writing of the second data from the buffer to the first cache line in the cache further includes setting a coherency state of the first cache line to (M)odified.

Example 33 includes the substance of any one of examples 27-32, and further including a first predictor circuitry to deactivate the redundant write detection circuitry responsive to a determination that power consumed by the redundancy check is greater than power saved by the redundancy check.

Example 34 includes the substance of example 33. In this example, the power consumed by the redundancy check is based on a number of accesses made to the cache resulting from performing the redundancy check.

Example 35 includes the substance of any one of examples 33-34. In this example, the power saved by the redundancy check is based on reductions in write accesses to the cache and to the memory resulting from performing the redundancy check.

Example 36 includes the substance of any one of examples 27-35, and further including a second predictor circuitry to deactivate the redundant write detection circuitry responsive to a determination that memory bandwidth saved resulting from performing the redundancy check is not being utilized by memory reads.

Example 37 includes a system-on-chip that includes at least processor of any one of example 24-36.

Example 38 is a processor or other apparatus operative to perform the method of any one of examples 14-23.

Example 39 is a processor or other apparatus that includes means for performing the method of any one of example 14-23.

Example 40 is an optionally non-transitory and/or tangible machine-readable medium, which optionally stores or otherwise provides instructions including a first instruction, the first instruction if and/or when executed by a processor, computer system, electronic device, or other machine, is operative to cause the machine to perform the method of any one of examples 14-23.

Example 41 is a processor or other apparatus substantially as described herein.

Example 42 is a processor or other apparatus that is operative to perform any method substantially as described herein.

Example 43 is a processor or apparatus that is operative to perform any description of instruction substantially as described herein.

What is claimed is:

1. A system comprising:
a plurality of processors;
a memory coupled to one or more of the plurality of processors;
a cache coupled to the memory, wherein a dirty cache line evicted from the cache is written to the memory; and
a redundant write detection circuitry coupled to the cache, the redundant write detection circuitry to control write access to the cache based on a redundancy check of data to be written to the cache.

2. The system of claim 1, wherein the cache is a Last Level Cache (LLC).

3. The system of claim 1, wherein the cache is a Level 3 (L3) cache.

4. The system of claim 1, wherein the redundancy check comprises:
detecting a write request comprising an address corresponding to a first cache line in the cache;
responsive to the detection, copying a first data of the first cache line from the cache to a buffer;
receiving a second data corresponding to the write request and responsively comparing the second data to the first data in the buffer;
replacing the first data in the buffer with the second data responsive to a determination that the first data in the buffer is different than the second data; and
removing the first data from the buffer responsive to a determination that the first data in the buffer is same as the second data.

5. The system of claim 4, wherein the write request is initiated by a write back request from a processor core.

6. The system of claim 4, wherein the write request is initiated by a cache line eviction from a second cache.

7. The system of claim 4, wherein the redundancy check further comprises discarding the second data responsive to the determination that the first data in the buffer is same as the second data.

8. The system of claim 4, wherein the redundancy check further comprises writing the second data from the buffer to the first cache line in the cache responsive to the determination that the first data in the buffer is different than the second data.

9. The system of claim 8, wherein writing the second data from the buffer to the first cache line in the cache further comprises setting a coherency state of the first cache line to (M)odified.

10. The system of claim 1, further comprising a first predictor circuitry to deactivate the redundant write detection circuitry responsive to a determination that power consumed by the redundancy check is greater than power saved by the redundancy check.

11. The system of claim 10, wherein the power consumed by the redundancy check is based on a number of accesses made to the cache resulting from performing the redundancy check.

12. The system of claim 10, wherein the power saved by the redundancy check is based on reductions in write accesses to the cache and to the memory resulting from performing the redundancy check.

13. The system of claim 1, further comprising a second predictor circuitry to deactivate the redundant write detection circuitry responsive to a determination that memory bandwidth saved resulting from performing the redundancy check is not being utilized by memory reads.

14. A method comprising:
detecting a write request comprising an address corresponding to a first cache line in a cache;
responsive to the detection, copying a first data of the first cache line from the cache to a buffer;
receiving a second data corresponding to the write request and responsively comparing the second data to the first data in the buffer;
replacing the first data in the buffer with the second data responsive to a determination that the first data in the buffer is different than the second data; and
removing the first data from the buffer responsive to a determination that the first data in the buffer is same as the second data.

15. The method of claim 14, wherein the cache is a Last Level Cache (LLC).

16. The method of claim 14, wherein the cache is a Level 3 (L3) cache.

17. The method of claim 14, wherein the write request is initiated by a write back request from a processor core.

18. The method of claim 14, wherein the write request is initiated by a cache line eviction from a second cache.

19. The method of claim 14, further comprising discarding the second data responsive to the determination that the first data in the buffer is same as the second data.

20. The method of claim 14, further comprising writing the second data from the buffer to the first cache line in the cache responsive to the determination that the first data in the buffer is different than the second data.

21. The method of claim 20, wherein writing the second data from the buffer to the first cache line in the cache further comprises setting a coherency state of the first cache line to (M)odified.

22. The method of claim 14, further comprising determining a power consumption for locating the first cache line in the cache and copying the first data of the first cache line from the cache to the buffer.

23. The method of claim 14, further comprising determining a power saving resulting from not having to write the first data from the buffer to the cache as a result of removing the first data from the buffer.

24. A processor coupled to a memory, the processor comprising:
a plurality of cores;
at least one shared cache to be shared among two or more of the plurality of cores, wherein a dirty cache line evicted from the cache is written to the memory; and
a redundant write detection circuitry coupled to the cache, the redundant write detection circuitry to control write access to the cache based on a redundancy check of data to be written to the cache.

25. The processor of claim 24, wherein the redundancy check comprises:
detecting a write request comprising an address corresponding to a first cache line in the cache;
responsive to the detection, copying a first data of the first cache line from the cache to a buffer;
receiving a second data corresponding to the write request and responsively comparing the second data to the first data in the buffer;
replacing the first data in the buffer with the second data responsive to a determination that the first data in the buffer is different than the second data; and
removing the first data from the buffer responsive to a determination that the first data in the buffer is same as the second data.
